(19) United States
(12) Patent Application Publication
(10) Pub. No.: US 2013/0280388 A1
(43) Pub. Date: Oct. 24, 2013

(54) Solid Food Products and Methods of Their Preservation

(71) Applicants: Athula Ekanayake, Cincinnati, OH (US); Jairus R. David, Omaha, NE (US); Clinton Lewis Johnson, Omaha, NE (US); Kari Dalene Sweeney, Glenwood, IA (US)

(72) Inventors: Athula Ekanayake, Cincinnati, OH (US); Jairus R. David, Omaha, NE (US); Clinton Lewis Johnson, Omaha, NE (US); Kari Dalene Sweeney, Glenwood, IA (US)

(21) Appl. No.: 13/454,112

(22) Filed: Apr. 24, 2012

(51) Int. Cl. A23L 3/01; A23L 3/34; A23L 3/26

(52) U.S. Cl. 426/241; 426/237; 426/532

(57) ABSTRACT

Disclosed herein are solid food products comprising an isothiocyanate compound. Also disclosed are methods of preserving solid food products comprising such isothiocyanate compounds. In one embodiment, the methods comprise providing a solid food product comprising an isothiocyanate compound and exposing the solid food product to energy input to cause thermal heat. In one embodiment the energy input may be microwave radiation.

### FIELD OF THE INVENTION

The present invention is directed to solid food products comprising an isothiocyanate compound. The present invention is further directed to methods of preserving solid food products comprising such isothiocyanate compounds.

### BACKGROUND OF THE INVENTION

Food products can provide a hospitable environment for rapid microbial growth. Such exposure can, and frequently does, result from inadvertent microbial inoculation of the product during manufacturing or packaging. Spoilage and pathogenic microorganisms, for example in food products, can then rapidly proliferate by feeding on nutrients provided by the food product.

Preservatives, such as sorbates, benzoates, organic acids, and combinations thereof have been used in various products, particularly foods and beverages, to provide some degree of microbial inhibition. However, at levels effective to inhibit microbial growth, some of these preservatives can contribute off-flavors in the product, thus making the product undesirable for its intended purpose. Similarly, natural preservatives, such as natamycin, are frequently used in food and beverage products to inhibit microbial growth. Unfortunately, while these natural preservatives may be effective against either yeast or bacteria, they may not be effective against both.

It has been disclosed that the essential oil of mustard plants, which contain isothiocyanates, exhibits an antibacterial and antimycotic effect in oral therapies and on certain foods. See e.g., Sekiyama et al., U.S. Pat. No. 5,334,373, assigned to Nippon Sanso Corp., issued Aug. 2, 1994; and Madaus et al., U.S. Pat. No. 3,998,964, issued Dec. 21, 1976. The isothiocyanate compounds in mustard essential oils are the active agents that provide the antimicrobial effect. The essential oil derived from white or yellow mustard plants (Sinapis alba or Brassica alba), also provides the foregoing antibacterial and antimycotic benefits. However, the principal isothiocyanate present in the white mustard essential oil, 4-hydroxybenzyl isothiocyanate, is a moisture-sensitive compound that begins to degrade (i.e. hydrolyze) within hours of being exposed to moisture. When degraded, the 4-hydroxybenzyl isothiocyanate forms, among other compounds, 4-hydroxybenzyl alcohol in a temperature dependant manner. Recognizing this, it has been previously disclosed that maintaining internal temperatures of food products is important to avoid isothiocyanate degradation. See WO 2005/032283.

As such, practical use of isothiocyanates with foods that require heating such as, for example, foods that are shipped frozen and heated in the home kitchen setting, has not been fruitful. Despite prior understandings of isothiocyanate compounds used as preservatives, including its relative instability, it is discovered herein that use of heat coupled with use of such isothiocyanate compound achieves a synergistic anti-microbial effect that may not be achieved through employment of heat alone or employment of isothiocyanate compound alone. This is an important discovery that is contrary to expected properties of isothiocyanate compounds and may advance the use of applicability of food preservation science both in the industrial as well as the home use setting. In addition, substantially frozen solid food products comprising an isothiocyanate compound are now possible since such solid food products may be advantageously prepared in accordance with methods herein while still maintaining anti-microbial efficacy.

### SUMMARY OF THE INVENTION

The present invention is directed to methods of preserving a solid food product. In one embodiment, the method comprises:

(a) providing a solid food product comprising an isothiocyanate compound;
(b) exposing the solid food product to microwave radiation at a level of at least about 450 W power for at least about 30 seconds.

In another embodiment, the method comprises:

(a) providing a solid food product comprising an isothiocyanate compound;
(b) exposing the solid food product to energy input causing thermal heat in any portion of the product;
wherein at least any portion of the solid food product exhibits a temperature of at least about 37° C. for at least about 30 seconds.

### DETAILED DESCRIPTION OF THE INVENTION

Publications and patents may be referred to throughout this disclosure. All references cited herein are hereby incorporated by reference.

All percentages, ratios, and proportions used herein are by weight unless otherwise specified.

In the description of the invention various embodiments and/or individual features are disclosed. As will be apparent to the ordinarily skilled practitioner all combinations of such embodiments and features are possible and can result in preferred executions of the invention.

The products herein may comprise, consist essentially of, or consist of any of the components as described herein.

As used herein, the term “ppm” means parts per million as commonly understood in the art.

### Solid Food Products

The solid food products are ingestible compositions comprising at least one component that does not readily flow under the force of gravity at a temperature that is typical for the storage or ingestion of that product. All ingestible compositions that are at least partially frozen (such as, for storage) are solid food products, but a solid food product need not be frozen, either partially or otherwise. Examples of solid food products include, but are not limited to, stews, pot pies, and other heterogeneous foods, fruits, vegetables, meats (such as beef, pork, poultry, and fish), natural and processed cheeses, baked goods, snack foods, margarines, spreads, and gelled food compositions. The solid food products herein may comprise fluid products that are intended to be blended, mixed, injected, or otherwise incorporated into a finished solid food product, or applied to the surface of a solid food product, or prepared into food products. Examples include marinades, brine solutions, tenderizing solutions, dressings, sauces, gravies, liquid egg products, dairy based creams, tomato based sauces, pizza sauces and the like that are intended as a component of the solid food products. In one embodiment herein, the solid food product comprises a sauce. In one embodiment herein, the solid food product comprises at least one vegetable such as, for example, carrots, peas, beans, potatoes, and the like. In one embodiment herein, the solid food product comprises at least one meat such as, for example, beef, pork, chicken, fish, and the like. In one embodiment herein, the solid food product is a stew or a pot pie.

The solid food products made in accordance with the methods herein comprise an isothiocyanate compound (i.e., a compound bearing a —N═C═S moiety), such as, for example, the compound 4-hydroxybenzyl isothiocyanate, which is present in white mustard essential oil. While such compounds have been previously identified as having beneficial antimicrobial activity in food products, they are often used in combination with the known preservatives benzoic acid, sorbic acid or salts thereof. A possible reason for this is the inherent sensitivity to moisture-induced hydrolytic degradation that has not been fully recognized, hence the need for an additional preservative. As such, the isothiocyanate compound may be a moisture-sensitive isothiocyanate compound, such as 4-hydroxybenzyl isothiocyanate. As used herein, the term “moisture-sensitive” means that the isothiocyanate compound degrades in the presence of water. This degradation proceeds via a hydrolysis reaction, thereby leading to a reduction in level of the active isothiocyanate antimicrobial agent with time of storage in the presence of water. The method for determining moisture sensitivity is set forth in the Test Method section below. Moisture-sensitive isothiocyanates are characterized by a reduction in concentration of the isothiocyanate compound of at least about 20% of the starting concentration, when suspended in an aqueous phosphate buffer having a pH of about 3.6, and a temperature of from about 20° C. to about 23° C., over a 24 hour period.

The present inventors have discovered that relatively low levels of the compound produce the desired antimicrobial effect in the present solid food products and methods. In this regard, the solid food product may comprise at least about 100 ppm, or at least about 250 ppm, or at least about 450 ppm, or at least about 750 ppm, of the isothiocyanate compound.

Any isothiocyanate compound bearing a —N═C═S moiety may be utilized in the present invention, provided that it is suitable for ingestion by a mammal, including for example a human. Preferably, the isothiocyanate compound utilized in the present compositions has the structure:

R—N═C═S

wherein R is the 4-hydroxybenzyl or para-hydroxybenzyl moiety. This structure is commonly known as 4-hydroxybenzyl isothiocyanate or p-hydroxybenzyl isothiocyanate, and may be synthetically obtained or alternatively naturally obtained from, for example, white mustard.

In one embodiment, the component comprising the isothiocyanate compound is an essential oil, natural component of an essential oil, or synthetic component of an essential oil (all as described in more detail hereafter) of the white or yellow mustard family (Sinapis alba or Brassica alba). As is known, the Brassica family of plants is a small family having about 2000 species and over 300 genera (see e.g. Natural Food Antimicrobial Systems, edited by A. S, Naidu, CRC Press LLC, pp. 399-416, 2000). Alternatively, the component comprising the moisture-sensitive isothiocyanate compound may be an essential oil, natural component of an essential oil, or synthetic component of an essential oil of any other family of plants which may produce a moisture-sensitive isothiocyanate compound. See e.g., Food Chemistry, Edited by O. R. Fennema, Marcel Dekker, Inc., pp. 602-603 (1985) and Naturally Occurring Antimicrobials in Food, Council for Agricultural Science and Technology, pp. 31-32 (1998).

In one embodiment of the present invention, an essential oil or, most preferably a natural component thereof, may be used as a component of the present solid food products. Wherein an essential oil, or natural component thereof, is utilized as a constituent of the present products, the oil is preferably derived from a plant which is a member of the Brassica family; a non-limiting preferred example being 4-hydroxybenzyl isothiocyanate. As used herein, “essential oil” refers to the set of all the compounds that can be distilled or extracted from the plant from which the oil is derived and that contributes to the characteristic aroma of that plant. See e.g., H. McGee, On Food and Cooking, Charles Scribner's Sons, p. 154-157 (1984). In accordance with one embodiment of the present invention, the essential oil may originate from white or yellow mustard plant (Sinapis alba or Brassica alba), which is capable of producing a moisture-sensitive isothiocyanate compound, including but not limited to, 4-hydroxybenzyl isothiocyanate. The essential oil may be obtained using procedures that are commonly known in the art.

As is known in the art, the seeds and/or flowers (preferably seeds) of any of, for example, a Brassica species, may be homogenized, ground, crushed, pressed, or otherwise damaged to activate one or more precursors (e.g., glucosinolates) of the corresponding essential oil. Isothiocyanate compound production from the oil is known to occur by enzyme catalysis upon, for example, homogenizing, grinding, crushing, pressing, or otherwise damaging the plant, seed and/or flower thereof. See e.g., Concannon, WO 94/01121, published Jan. 20, 1994 and Brown et al., “Glucosinolate-Containing Plant Tissues as Bioherbicides”, Journal of Agricultural Food Chemistry, Vol. 43, pp. 3070-3074 (1995). The enzyme commonly known to participate in the production of the isothiocyanate compound upon interaction with a glucosinolate is myrosinase, which is also known as thioglucoside glucohydrolase (and having enzyme classification number EC 3.2.1.147). Myrosinase is known to be non-specific for various glucosinolates.

The essential oil may be obtained by any of a variety of known methods. For example, the plant utilized may be homogenized, ground, crushed, pressed, or otherwise damaged (e.g., cut); the essential oil may then be extracted using an organic solvent, for example, an alcohol (e.g., ethanol) or diethyl ether or ethyl acetate, or a compound such as propylene glycol. See e.g., Ono et al., “6-Methylsulfinylhexyl Isothiocyanate and Its Homologues as Food-originated Compounds with Antibacterial Activity against Escherichia coli and Staphylococcus aureus”, Bioscience, Biotechnology, and Biochemistry, Vol. 62(2), pp. 363-365 (1998). Alternatively, the essential oil may be obtained via distillation (for example, steam distillation depending upon the volatility of the isothiocyanate compound present therein) after homogenizing, grinding, crushing, pressing, or otherwise damaging the plant, seed, flower, and/or any other component thereof. See e.g., Isshiki et al., “Preliminary Examination of Allyl Isothiocyanate Vapor for Food Preservation”, Bioscience, Biotechnology, and Biochemistry, Vol. 56(9), pp. 1476-1477 (1992).

Alternatively, the essential oil may be extracted using a supercritical fluid such as carbon dioxide, after homogenizing, grinding, crushing, pressing, or otherwise damaging the plant, seed, flower, and/or any other component thereof. Such processes are described in U.S. Pat. Nos. 5,017,397 and 5,120,558. Upon extraction of the essential oil, the extracts are preferentially stabilized by removing residual water from the extract by centrifugation, decanting, passage through a molecular sieve, exposure to an anhydrous salt, or drying under vacuum.

Illustrative examples of processes of extracting isothiocyanate compounds may be found in, for example, WO 2005/032283; WO 2011/123280; and WO 2011/123281 (Ekanayake et al., The Procter & Gamble Company).

The essential oil itself, which contains one or more moisture-sensitive isothiocyanate compounds, such as 4-hydroxybenzyl isothiocyanate, may then be utilized in the solid food products and methods of the present invention.

Alternatively, a natural component of the essential oil may be utilized. As used herein, the term “natural component,” with reference to the corresponding essential oil, refers to a component utilized in the present invention that is obtained from the naturally occurring essential oil. In one embodiment, the essential oil is may be derived from a Brassica family plant. As stated herein above, the natural component of the essential oil should comprise one or more moisture-sensitive isothiocyanate compounds (i.e., a compound bearing a —N═C═S moiety), such as 4-hydroxybenzyl isothiocyanate.

The method by which the natural component is obtained from the essential oil is not critical to the present invention. According to the present invention, the natural component should comprise a moisture-sensitive isothiocyanate compound and may optionally comprise further components derived from the essential oil. To illustrate, the natural component of the essential oil may be obtained through standard purification of the essential oil itself to obtain one or more isothiocyanate compounds using, for example, extraction, chromatography, or distillation. For example, common chromatography techniques (e.g., HPLC) may be utilized to obtain a natural component of the essential oil. See e.g., Ono et al., “6-Methylsulfinylhexyl Isothiocyanate and Its Homologues as Food-originated Compounds with Antibacterial Activity against Escherichia coli and Staphylococcus aureus”, Bioscience, Biotechnology, and Biochemistry, Vol. 62(2), pp. 363-365 (1998). As a further example, an essential oil once distilled or extracted (the essential oil itself) may again be distilled or extracted to remove volatile components not of interest or to remove the isothiocyanate compound of interest. It is a preferred embodiment of the present invention to utilize a natural component of the essential oil.

Alternative to utilizing the essential oil or natural component thereof in the present invention, a synthetic component of an essential oil, preferably a Brassica essential oil, may be utilized. As used herein, the term “synthetic component” with reference to the corresponding essential oil refers to a component utilized in the present invention that naturally occurs in an essential oil which has been activated through myrosinase, but which is obtained through synthetic techniques without extraction or purification from a naturally occurring essential oil. As stated herein above, the synthetic component of the essential oil should comprise one or more moisture-sensitive isothiocyanate compounds (i.e., a compound bearing a —N═C═S moiety), such as 4-hydroxybenzyl isothiocyanate.

A variety of synthetic isothiocyanate compounds may be commercially obtained, for example, from Aldrich Chemical Co., Milwaukee, Wis.; Fluka Chemical Co., Milwaukee, Wis.; Sigma Chemical Co., St. Louis, Mo.; and Lancaster Synthesis Inc., Windham, N.H. Additionally, synthetic methods of preparing isothiocyanate compounds are well-known in the art. See e.g., J. March, Advanced Organic Chemistry, John Wiley & Sons (1992). Additionally, natural production of isothiocyanate compounds may be synthetically mimicked by commercially obtaining one or more glucosinolate compounds and introducing myrosinase which may be isolated from any myrosinase producing plant (as discussed above) or commercially obtained (for example, myrosinase is commercially available as thioglucosidase from Sigma Chemical Co., St. Louis, Mo.). Alternatively, natural production of isothiocyanate compounds may be synthetically mimicked by isolating a glucosinolate compound from any glucosinolate producing plant and introducing myrosinase that is commercially obtained.

There are a variety of methods by which to add the isothiocyanate preservative composition to the solid food product, including, but not limited to, blending or otherwise mixing into a solid food matrix (e.g. ground beef) or preparing a liquid solution or dispersion comprising the isothiocyanate preservative composition (e.g. wash solution, brine solution, tenderizing solution, or marinade) into which a solid food product (such as a fruit, vegetable, or cut of meat, poultry, or fish) is dipped or immersed to apply the preservative to the surface. Alternatively, a liquid solution or dispersion comprising the isothiocyanate preservative composition (e.g. brine solution, tenderizing solution, or marinade) may be sprayed, brushed, or otherwise coated onto the surface of the solid food product (such as, for example, a beef or poultry carcass), or it may be incorporated into the interior of the solid food product by pressure injection or vacuum tumbling. Pressure injection and vacuum tumbling are especially preferred methods for incorporating the isothiocyanate preservative composition into intact cuts of meat, such as beef, pork, poultry, and fish. The isothiocyanate preservative compositions may also be incorporated into the materials used in the packaging of solid food products, which because of the intimate contact between the package material and the solid food product, allows for the transfer of the preservative composition to the surface of the food product. A non-limiting example of such packaging material includes the absorbent pads placed under cuts of meat, such as poultry, that are intended for retail distribution.

In an optional embodiment herein, the solid food products are essentially free of sorbate, benzoate and salts thereof, which means that the referenced solid food product comprises less than about 0.0005% by weight of combined sorbate, benzoate, and salts thereof (i.e., less than about 5 ppm).

In an optional embodiment herein, the solid food products comprise a hygroscopic carrier. As used herein, the term “hygroscopic carrier” means a substance that is capable of attracting, absorbing, and binding moisture. Such substance may be in liquid, powdered or granular solid form.

Any number of hygroscopic carriers may be used in the present invention. Suitable liquid hygroscopic carriers include, but are not limited to, glycerin, polyethylene glycol, and propylene glycol. Suitable powdered or granular solid hygroscopic materials for use as carriers include, but are not limited to, polysaccharides (including maltodextrins, starches, and microcrystalline cellulose), oligosaccharides, sugars (including glucose, fructose, sucrose, maltose, and lactose), sugar alcohols (including mannitol, maltitol, erythritol, and sorbitol), salt, silicon dioxide (including precipitated and fumed silicas), and anti-caking agents and/or flow agents (including sodium silicoaluminate, calcium silicate, magnesium silicate, tricalcium phosphate, and magnesium carbonate). Particularly preferred carriers are maltodextrin and glycerin. The type of hygroscopic carrier used will depend on the ultimate application for the preservative composition. For instance, for many uses the preferred carrier will be one of the powdered or granular solid materials, in particular maltodextrin, because of the ease of handling and shipping of the preservative composition. However, there may be certain instances in which a liquid preservative composition may be preferred because of its capability to be pumped or injected and/or because of its flow properties that may be critical for effective coating of the surfaces of solid food products. For example, use of glycerin as the hygroscopic carrier may be particularly effective when the preservative composition is blended into a ground beef product, in which the capability of the preservative composition to flow and uniformly coat the individual ground beef pieces may be beneficial.

Wherein the solid food product comprise a hygroscopic carrier, the products may typically comprise from about 90% to about 99.9%, or from about 92% to about 99.9%, or from about 94% to about 99.9%, or from about 96% to about 99.9%, all by weight of the hygroscopic carrier.

In one embodiment herein, the isothiocyanate compound may be diluted in a hygroscopic carrier. There are numerous methods by which to dilute the isothiocyanate compound. For example, the isothiocyanate compound or the essential oil comprising the isothiocyanate compound may be dissolved, dispersed, or otherwise uniformly blended in a liquid hygroscopic carrier. Alternatively, the isothiocyanate compound or the essential oil comprising the isothiocyanate compound may be triturated with, plated onto, or otherwise intimately mixed with the solid particles of a powdered or granular hygroscopic carrier. Trituration is a preferred process, in which the isothiocyanate compound or the essential oil comprising the isothiocyanate compound and the hygroscopic powder or granular material are intimately mixed by pulverizing and/or comminuting thoroughly by rubbing or grinding. Plating of the isothiocyanate compound or the essential oil comprising the isothiocyanate compound onto the solid particles of a powdered or granular hygroscopic carrier refers to the process of coating the surface of such particles with a film or coating of the isothiocyanate compound or essential oil.

In one embodiment herein, the present invention is directed to solid food products that are substantially frozen. As used herein, “substantially frozen” refers to solid food products in which at least 90% of the solid food product, by weight of the solid food product, has an internal temperature of less than about −5° C. (i.e., negative 5° C.). As used herein, “frozen” refers to solid food products in which at least 95% of the solid food product, by weight of the solid food product, has an internal temperature of less than about −10° C. (i.e., negative 10° C.). Means of achieving substantially frozen and frozen solid food products will be well understood in the art and are further exemplified by the examples herein.

Wherein the solid food product is substantially frozen or frozen, the isothiocyanate compound may be introduced as a component of the solid food product prior to, during, or subsequent to the freezing process. In one embodiment, the solid food product is prepared, including the isothiocyanate compound, prior to the freezing process. This is accomplished through known methods of manufacturing such solid food products. In one embodiment, the manufacturing process includes dispersion of the isothiocyanate compound into a component such as a sauce or other filling, and then blended with solid components, such as vegetables. The solid food product is then frozen and shipped to retail distribution such as a grocery wherein it is purchased by a consumer. In this illustrative embodiment, the consumer directly performs the heating steps described herein, just prior to consumption.

In other embodiments, the solid food products may be provided at different temperature states such as refrigerated or shelf-stable states. Energy introduction may be provided by the manufacturer at the food manufacturing site such as during hot fill n hold or aseptic packaging or other process steps.

### Methods of the Present Invention

Despite prior understandings of isothiocyanate compounds used as preservatives, including relative instability, it is discovered herein that use of energy inputs resulting in heat, with the use of such isothiocyanate compound, achieves a synergistic anti-microbial effect that may not be achieved cumulatively through employment of heat alone and the employment of isothiocyanate compound alone. This is an important discovery that may advance the food preservation science both in the industrial as well as the home use setting. As described herein use of the present methods and solid food products may inhibit growth of, eliminates, and/or otherwise decreases the presence of microorganisms such as, for example, yeast, bacteria, mold, and/or fungus, preferably yeast and/or bacteria. For examples Salmonella and/or Listeria strains may be inhibited, eliminated, or otherwise diminished in the solid food products relative to other methods and products used.

The present invention is directed to methods of preserving a solid food product. In one embodiment, the method comprises:

(a) providing a solid food product comprising an isothiocyanate compound;
(b) exposing the solid food product to microwave radiation at a level of at least about 450 W power for at least about 30 seconds.

In another embodiment, the method comprises:

(a) providing a solid food product comprising an isothiocyanate compound;
(b) exposing the solid food product to energy input causing thermal heat in any portion of the solid food product;
wherein at least any portion of the solid food product exhibits a temperature of at least about 37° C. for at least about 30 seconds.

Exposure of the solid food product to the energy input may occur, for example, during commercial manufacture or in an at-home setting during personal food preparation.

The isothiocyanate compound utilized is described as herein above with respect to the solid food products. The solid food product is provided in accordance with known methods and/or as described herein above.

Microwave ovens may be any of a variety of different sizes. Those microwave ovens that are appropriate for home use may be at least about 0.5 cubic feet, or at least about 0.7 cubic feet, or at least about 0.9 cubic feet, or at least about 1.1 cubic feet, or at least about 1.4 cubic feet, or at least about 1.5 cubic feet, or at least about 2.2 cubic feet. This measurement refers to the capacity of the microwave oven, as is commonly understood in the art.

Microwave radiation is commonplace for industrial and home use, with microwave ovens (colloquially referred to as “microwaves”) being commonly used kitchen appliances. Microwave ovens are commercially available with differing Watts power (herein, “W power”). W power for some microwave ovens may also be selected by the user. In one embodiment of the present invention, the solid food product is exposed to at least about 450 W power, or at least about 700 W power, or at least 1100 W power, or at least about 1250 W power. In one embodiment of the present invention, the solid food product is exposed to from about 450 W power to about 1500 W power, or from about 700 W power to about 1250 W power, or from about 700 W power to about 1100 W power.

The exposure to W power microwave radiation may be constant or variable, as will be commonly understood in the art. For example, solid food products that are obtained in a frozen state by the user may be defrosted using microwave radiation; sometimes in this circumstance, the user will choose variable W power to defrost the solid food product. For example, the user may expose the solid food product to 50% of full power of the microwave oven for 1 minute, followed by full power of the microwave oven for 2 minutes, and so on, for a total time that is sufficient to defrost the solid food product as deemed by the user.

It is found herein that duration of exposure to heat is an important factor and that the rate of degradation of the isothiocyanate is reduced when used in accordance with the specifications herein. Consequently, the residence time or life time of the active isothiocyanate antimicrobial compound is prolonged and the resultant antimicrobial efficacy is enhanced. Time of exposure to the microwave radiation may be variable and may be selected in accordance with the type of solid food product that is exposed, the temperature of the solid food product prior to exposure (e.g., whether the solid food product is substantially frozen, or not), the W power of the microwave oven used, or any of a variety of other factors. In one embodiment, the solid food product is exposed to the microwave radiation for at least about 30 seconds, or at least about 60 seconds, or at least about 90 seconds, or at least about 120 seconds, or at least about 180 seconds, or at least about 210 seconds, or at least about 240 seconds, or at least about 270 seconds, or at least about 300 seconds, or at least about 330 seconds, or at least about 360 seconds. In one embodiment, the solid food product is exposed to the microwave radiation for from about 30 seconds to about 480 seconds, or from about 30 seconds to about 420 seconds, or from about 90 seconds to about 300 seconds, or from about 180 seconds to about 240 seconds. Time of exposure refers to the amount of time during which the solid food product is exposed to microwave radiation and does not include any time in which microwave radiation has been temporarily ceased in order to, for example, observe temperature of the solid food product, stir or otherwise mix the solid food product in accordance with the description immediately below.

Since microwave radiation may result in uneven heating, any of a variety of techniques may be used to distribute heat as well as the isothiocyanate compound through the solid food product. For example, it may be advantageous to employ a microwave oven having a fan, turntable, or any of a variety of other devices that assist with more even heating of the solid food product. Exposure to the microwave radiation may also be temporarily ceased in order to manually stir or otherwise mix the components of the solid food product in an effort to distribute heat throughout the solid food product. This may provide the benefit of further exposing the isothiocyanate compound to microorganisms that are to be killed during the microwave radiation exposure.

The present methods are not limited to those which employ microwave radiation. For example, in one embodiment, the methods of the present invention comprise exposing the solid food product to energy input causing thermal heat in any portion of the solid food product, wherein at least any portion of the solid food product exhibits a temperature of at least about 37° C. for at least about 30 seconds. In this embodiment, the energy input causing thermal heat is created through any of a variety of means such as, for example, microwave radiation, stovetop heating, oven heating, steam heating, ultrasound, electric pulse, and other types of heating vessels using conventional or other heating techniques. Exposure of the solid food product to the energy input may occur, for example, during commercial manufacture or in an at-home setting during personal food preparation. Wherein the exposure of the solid food product is in an at-home setting techniques may typically include, but are not limited to, microwave radiation, stovetop heating, and oven heating, or any combination thereof.

In this embodiment, at least a portion of the solid food product exhibits the referenced temperature (since it is common that not all of the solid food product will exhibit the same temperature in all loci of the solid food product). In one embodiment, at least about 25%, or at least about 50%, or at least about 75% of the solid food product, all by weight of the solid food product, exhibits the referenced temperature.

In one embodiment, the referenced portion of the solid food product exhibits a temperature of at least about 37° C., or at least about at least about 42° C., or at least about at least about 57° C., or at least about at least about 65° C., or at least about at least about 70° C. or at least about at least about 82° C., or at least about at least about 100° C. In one embodiment, the referenced portion of the solid food product exhibits a temperature of from about 37° C. to about 100° C., or from about 42° C. to about 82° C., or from about 57° C. to about 70° C., or from about 65° C. to about 70° C.

Internal temperature of a food product subject to cooking by microwaves can be measured by quickly removing the food product that is being cooked in the microwave oven and measuring the temperature using a conventional method such as a thermocouple or resistance based device. However such a method may be prone to error as there is a lag time associated with the measurement. Especially in microwave heating where uneven heating can occur, adjacent areas of differing temperature can transfer heat in between them and thus give erroneous measurements. Fiber optic temperature probes using the various scattering properties of light with temperature can be used to measure the actual or “real time” temperature of a food being cooked by a microwave oven. Fiber optic probes are non-metallic and function by purely optical means and are thus not sensitive to electromagnetic radiation such as microwaves being emitted within the oven cavity. Small holes of diameter about 1 mm can be drilled into the frozen food and the optical probes placed into these holes carefully to avoid damaging the polished probe ends. The food product can be placed within the cavity of a microwave oven while the probes can be extended outside of the closed microwave oven and connected to a measuring device. During cooking with increasing microwave energy absorbed by the food product its temperature will increase, consequently causing differences in the various scattering properties of the laser light being transmitted within these probes. These differences are detected by the measuring device and converted to temperature and a real time temperature reading of the food provided. With increasing temperature, the frozen areas of the food will thaw thus loosening the probes from their initial placement points. A scaffold made of paper or plastic can be placed within the frozen food or the holes can be drilled from the bottom of the container holding the food to prevent the movement of the probes during the heating beyond the frozen phase.

Where continuous heating by microwaves occur for example in a section of tubing through which the food passes, such optical probes can be fixed to the internal surface to measure the temperature of the food or conventional means can be used to measure the temperature of the heated food immediately after the heating section of tube.

It is found herein that duration of exposure to heat is an important factor and that the rate of degradation of the isothiocyanate is reduced when used in accordance with the specifications herein. Consequently, the residence time or life time of the active isothiocyanate antimicrobial compound is prolonged and the resultant antimicrobial efficacy is enhanced. Time of heat exposure may be variable and may be selected in accordance with the type of solid food product that is exposed, the temperature of the solid food product prior to exposure (e.g., whether the solid food product is substantially frozen, or not), or any of a variety of other factors. In one embodiment, the referenced portion of the solid food product exhibits the referenced temperature for at least about 30 seconds, or at least about 60 seconds, or at least about 90 seconds, or at least about 120 seconds, or at least about 180 seconds, or at least about 210 seconds, or at least about 240 seconds, or at least about 270 seconds, or at least about 300 seconds, or at least about 330 seconds, or at least about 360 seconds. In one embodiment, the referenced portion of the solid food product exhibits the referenced temperature for from about 30 seconds to about 480 seconds, or from about 30 seconds to about 420 seconds, or from about 90 seconds to about 300 seconds, or from about 180 seconds to about 240 seconds. Stirring or other mixing of the solid food product may be advantageous as described hereinabove with respect to microwave radiation, and with conventional heating such mixing may be employed during heat exposure.

### Test Method for Identification of 4-Hydroxybenzyl Isothiocyanate and Moisture-Sensitive Isothiocyanate Compounds

Samples of food products containing added 4-hydroxybenzyl isothiocyanate (4-HBITC) are extracted with ethyl acetate to quantify 4-HBITC. The pooled ethyl acetate extracts are dried over anhydrous sodium sulfate to remove any residual moisture. The dried ethyl acetate extracts can be analyzed immediately or kept frozen at about −25° C. until they are analyzed.

Normal phase high performance liquid chromatography can be used to determine the concentration of 4-HBITC in food products. A Waters Alliance HPLC (model 2695), equipped with a Waters 996 photo-diode-array detector (PDA) equipped with a Betasil diol-100 column (Thermo Scientific, San Jose, Calif., USA) of dimensions 4.6 mm i.d.×250 mm length, packed with 5 μm particles, is used for this analysis. Gradient-elution is performed with isopropanol (IPA) and n-hexane at a flow rate of 1.3 mL/min. The mobile phase composition is changed by initially holding it at at 5% IPA in n-hexane for 2 min and then increasing to 25% IPA over 15 minutes, holding at 25% IPA for 0.5 min, and returning to 5% IPA over a 0.5 minute period. The column is re-equilibrated with 5% IPA in n-hexane for 3 minutes prior to making the next injection. The injection volume is 25 μL and the sample carousel is kept at 15° C. The PDA collects data from 210 to 400 nm and the chromatograms can be extracted at 276 nm. Standards for the normal phase analysis are prepared by serial dilution in 20/80, ethyl acetate/n-hexane covering the range from 1 to 500 μg/mL 4-HBITC. Normal phase HPLC standards contain 4-HBITC only. Calibration curves are calculated by performing linear regression with a 1/x² weighting factor on the area ratios of the standards. The ethyl acetate extract samples are analyzed on the normal phase system after diluting 10:1 with 20% ethyl acetate in n-hexane. An aliquot of 3-hydroxybenzyl alcohol is added to each sample and standard as an internal standard (1.0 mg/mL solution in 5% ethyl acetate in hexane, 20 μL/mL of sample or standard is added). 4-HBITC elutes with a retention time of about 8.85 minutes.

To prepare an analytical standard of 4-HBITC, white mustard essential oil (WMEO) is generated first by cold pressing white mustard seed to reduce its fixed oil content by about 20% to yield a partially defatted mustard meal with about 6% fat. The resulting partially defatted pellets are ground to a coarse powder and 4000 g weighed out. A mixture of 1200 g water and 8000 g ethyl acetate is stirred in a closed vessel and 0.92 g ascorbic acid added to the contents followed quickly by the partially defatted mustard meal that was weighed out before. After stirring the mixture for about 4 hours at room temperature, the slurry is centrifuged at 1700×g for 30 min to separate the 4-HBITC containing ethyl acetate layer. The clarified ethyl acetate is evaporated under vacuum to yield about 300 g of WMEO having a concentration of about 26% 4-HBITC.

About 60 g of the WMEO from above is gently contacted with n-hexane repeatedly (4×80 mL) and the oil layer and hexane layer separated by decanting. The pooled n-hexane extract is repeatedly extracted with methanol (4×80 mL). The methanol layer is back extracted with n-hexane (2×100 mL). The resulting methanol layer and the oil layer resulting from the earlier n-hexane extraction are pooled and the solvent removed under reduced pressure to yield about 12.8 g crude 4-HBITC. For further purification 4.5 g of the above material is dissolved in 14 mL dichloromethane to which 6 mL of n-hexane is added. This solution is used as the feed material for the Biotage Chromatography system (Biotage, Uppsala, Sweden). A 75 L Biotage KP-Sil (32-63 μm 60 A) column that is conditioned by washing with 4 L of ethyl acetate followed by 70% dichloromethane in hexane is used for purification of 4-HBITC. The column is eluted with 5 L of 80% dichloromethane in hexane followed by 12 L of 90% dichloromethane in hexane at a flow rate of 320-350 mL/min. The eluate is monitored by TLC and 6 fractions containing 4-HBITC pooled and evaporated to dryness under vacuum with the temperature not exceeding 30° C. This procedure is repeated two more times, and the purified 4-HBITC is combined. The combined 4-HBITC is further purified in a similar manner on the same 75 L Biotage KP-Sil column using 85% dichloromethane in hexane as eluent. Selected fractions (purity >92%) are combined and evaporated under vacuum at room temperature to dryness to give homogeneous 4-HBITC. The purity of 4-HBITC is checked by HPLC using the normal phase method described previously, and confirmed by Proton and ¹³C NMR. The final standard material is individually packaged in amber colored glass vials that are first tared and flushed with nitrogen with the final weight of each vial recorded for ease of handling the standards.

Moisture-sensitive isothiocyanate compounds are identified by suspending the isothiocyanate-containing material in an aqueous phosphate buffer (pH of about 3.6) at room temperature. The resulting suspension is shaken well, and a time zero sample is withdrawn into a separatory funnel and extracted with ethyl acetate. This extraction is repeated with two further volumes of ethyl acetate. The separated ethyl acetate layers are pooled and dried over anhydrous sodium sulfate and kept frozen before analysis of the time zero isothiocyanate concentration by supercritical fluid chromatography. To determine sensitivity of the isothiocyanate compound to hydrolytic degradation, the isothiocyanate suspension is stored at a temperature between about 20° C. to about 23° C. for a period of about 24 hours. The extraction procedure is repeated after 24 hours and the level of residual isothiocyanate compound is measured by supercritical fluid chromatography. Moisture-sensitive isothiocyanate compounds are characterized by at least about a 20% reduction in concentration of the isothiocyanate after about 24 hours, relative to the time zero or starting concentration.

### EXAMPLES

The following are non-limiting examples used in accordance with the present invention. The following examples are provided to illustrate the invention and are not intended to limit the scope thereof in any manner.

### Example 1

White mustard essential oil (WMEO) is prepared by first cold pressing white mustard seed (800 kg) was using a Rosedowns Mini 200 screw press. The resulting press cake (645 kg) exits the press at about 75-78° C. and is immediately cooled to room temperature by hammer milling. The oil content of the press cake is 17%, by weight of the press cake.

Hammer milled white mustard press cake (340 kg) from the above unit operation is introduced into a ribbon blender and ascorbic acid (1 mM, 78 g) added to it while blending to ensure uniform mixing. Room temperature water (102 kg) is added in small portions to ensure uniform wetting of the press cake and ascorbic acid mixture. After mixing for about 10-15 minutes, the moistened and myrosinase enzyme-activated press cake is transferred to a stirred solvent tank for extracting with ethyl acetate (626 kg). The moistened, activated press cake and ethyl acetate slurry is stirred within the closed solvent tank for about 4 hours at room temperature, to ensure maximum generation and transfer of the 4-HBITC from the moist white mustard press cake into ethyl acetate.

At the end of the reaction period, the slurry of moist white mustard press cake in ethyl acetate is pumped into a decanter centrifuge to separate the ethyl acetate from the moist white mustard press cake. The ethyl acetate layer is collected in a static solvent tank and pumped into a rising film evaporator coupled to an oil stripper kept under about 0.56 m Hg vacuum to remove the ethyl acetate from WMEO. This experiment yields about 64 kg of WMEO having 7.96% 4-HBITC, as determined by the analytical method described earlier.

To 305 g of the WMEO from above taken in a glass beaker, 695 g of peanut oil is added and the contents are mixed well to ensure homogeneity. The resulting 2.4% 4-HBITC containing WMEO in peanut oil solution is used to provide the 4-HBITC for the experiment discussed below. The solution is kept frozen at −25° C. until use.

### Example 2

Frozen pot pie fillings are made by first preparing a sauce containing chicken stock, dried chicken powder, autolyzed yeast extract and corn starch. To 8605 g of chicken stock in a mixing kettle, 118 g of dried chicken powder is added and mixed to ensure a smooth dispersion without clumps. Autolyzed yeast extract, 39 g is added to the solution and mixed to ensure that the viscous material disperses evenly. Then, 748 g of corn starch is dispensed slowly into the mixture and dispersed well avoiding the formation of clumps. This suspension of starch in the chicken broth is then heated to about 80-85° C. and held for about 30-33 minutes, with stirring to gelatinize the starch and pasteurize the sauce. Then the pasteurized sauce is cooled to 15-15.5° C. by pumping it through a heat exchanger and conveyed to a ribbon blender.

The particulates component comprising the pot pie filling are made by weighing out its components such as pre-frozen chicken cubes, potato cubes, carrot cubes and whole frozen peas. To 3420 g of pre-cooked and frozen chicken cubes, 945 g of blanched and individually-quick-frozen (IQF) carrot cubes, 795 g of IQF potato cubes and 330 g of IQF peas are added to obtain the particulate component of frozen pot pie fillings.

To the pasteurized sauce in the ribbon blender, the above mixture of IQF particulates is added while the sauce is being blended to obtain a total weight of 9510 g completed pot pie filling. The temperature of the pot pie filling keeps decreasing from a starting temperature of 15-15.5° C. to a final temperature of about 2-4° C.

While the stirring is continued the completed pot pie filling is added to the pie crust, covered with the top crust and the edges crimped to prepare the completed pot pie. Pot pies are individually packaged and kept frozen at −28 to 29° C.

### Example 3

Pot pie fillings made up of both Salmonellae inoculated particulates and gravy carrying the 4-hydroxybenzyl isothiocyanate (4-HBITC) in white mustard essential oil (WMEO), is used to evaluate the effect of 4-HBITC in a heterogeneous food system. Standing overnight cultures of five strains of Salmonellae are used to inoculate, at two different levels, mixtures of frozen vegetable and chicken particulates containing about 62% chicken, 17% carrot, 15% potato and 2% peas, as described in Example 2, all by weight of the total particulate mixture. The high level contains about 6 log colony forming units (cfu)/gm while the medium level contains about 3 log cfu/gm of Salmonellae. Bags containing the inoculated cultures and the particulates are gently inverted and rolled to ensure uniform coating of the particulates and the inoculated particles are then stored at −28° C. for 24 hours before being mixed with sauce containing white mustard essential oil (WMEO).

Sauce as made in Example 2 is used as the vehicle for WMEO. From a 2.4% 4-HBITC in WMEO stock solution in peanut oil made as described in Example 1, accurate amounts are weighed out such that 400 g of the pie filling comprising 36% of the particulates and 64% of the gravy will have 750, 562.5 or 250 ppm, 4-HBITC when mixed together. The particulates and the sauce are first put together in a sterile bowl and the WMEO in peanut oil added to the mixture and mixed gently for about 1 minute. The control (0 ppm 4-HBITC samples have only the vegetable oil added to them before mixing. The completed pie fillings are then immediately frozen at −28° C. for 48 hours before the second stage of the experiment.

To enumerate the accurate Salmonellae count prior to freezing, a sample is removed from each of the mixed pie fillings, including the control, and diluted at a ratio of 1:10 with Butterfields buffer and homogenized using a stomacher. The homogenized and diluted sample is suitably diluted further to obtain the appropriate number of bacterial colonies per plate and plated in triplicate on trypticase soy agar with yeast extract and allowed to stabilize for 30-60 minutes. The plates are then over-laid with xyline-lysine-deoxycholate (XLD) agar to resuscitate and recover injured cells and incubated at 35° C. for 48 hours before counting the colonies.

In the second stage of the experiment, the frozen pie fillings are cooked in 700 W or 1100 W microwave ovens. During cooking, samples are removed from the pie fillings at 15, 45, 60, 90 120, 180 and 240 seconds. At each of these time points, the surviving microbial counts are enumerated by removing discrete 25 g samples and plating them in the manner described above. To determine the effect of 4-HBITC only, each of the treatments and the control is thawed to room temperature and triplicate samples are used to enumerate the surviving microorganisms as detailed above.

The microbial reductions resulting from the treatments is attributed to the simultaneous action of microwave heating and 4-HBITC while microbial reductions occurring in the 0 ppm 4-HBITC containing control sample is attributed to microwave heating only. If the reduction in microbial counts due to the simultaneous action of 4-HBITC and microwave heating is greater than the sum of the individual reductions in microbial counts due to 4-HBITC and microwave heating, a synergistic effect is considered to be present (YES). If the reduction in microbial counts due to the simultaneous action of 4-HBITC and microwave heating is equal to or less than the sum of the individual reductions in microbial counts due to 4-HBITC and due to microwave heating, a synergistic effect is considered to be absent (NO).

The thermal profile suggests that sufficient thawing of the pie fillings occurs beyond about 120 seconds, thus mobilizing the 4-HBITC and making it available for its intended activity. The Table below shows a high number of time points in which a synergistic effect is observed for the 180 second time point.

| Treatment | | | log reductions (180 sec) due to | | | Synergistic |
|---|---|---|---|---|---|---|
| [4-HBITC] | Inoc. Level | MW power | 4-HBITC | Heat | Simultaneous action | effect |
| (ppm) | High/Med. | Watts | only | only | of 4-HBITC & heat | Yes/No |
| 750 | M | 700 | 2.4 | 1.41 | 4.38 | Yes |
| 750 | M | 1100 | 2.64 | 1.11 | 4.38 | Yes |
| 750 | H | 700 | 2.03 | 0.7 | 5.25 | Yes |
| 750 | H | 1100 | 2.14 | 0.45 | 1.56 | No |
| 562.5 | M | 700 | 2.4 | 1.41 | 4.38 | Yes |
| 562.5 | M | 1100 | 2.4 | 1.11 | 4.38 | Yes |
| 562.5 | H | 700 | 1.59 | 0.7 | 2.97 | Yes |
| 562.5 | H | 1100 | 1.59 | 0.45 | 5.25 | Yes |
| 250 | M | 700 | 1.15 | 1.41 | 1.42 | No |
| 250 | M | 1100 | 1.1 | 1.11 | 1.38 | No |
| 250 | H | 700 | 0.74 | 0.7 | 1.11 | No |
| 250 | H | 1100 | 1.05 | 0.45 | 1.63 | Yes |

What is claimed is:

1. A method for preserving a solid food product comprising:
(a) providing a solid food product comprising an isothiocyanate compound;
(b) exposing the solid food product to microwave radiation at a level of at least about 450 W power for at least about 30 seconds.

2. The method according to claim 1 comprising exposing the solid food product to microwave radiation at a level of at least about 700 W power for at least about 30 seconds.

3. The method according to claim 2 wherein the isothiocyanate compound is a moisture-sensitive isothiocyanate compound.

4. The method according to claim 3 comprising at least about 100 ppm of the moisture-sensitive isothiocyanate compound, wherein the moisture-sensitive isothiocyanate compound is 4-hydroxybenzyl isothiocyanate.

5. The method according to claim 4 comprising exposing the solid food product to microwave radiation at a level of at least about 700 W power for at least about 90 seconds.

6. The method according to claim 5 comprising exposing the solid food product to microwave radiation at a level of at least about 700 W power for at least about 180 seconds.

7. The method according to claim 6 wherein the solid food product comprises at least about 450 ppm of the 4-hydroxybenzyl isothiocyanate.

8. The method according to claim 6 wherein the solid food product comprises at least one vegetable.

9. The method according to claim 2 wherein the solid food product is substantially frozen prior to exposing the solid food product to the microwave radiation.

10. A method for preserving a solid food product comprising:
(a) providing a solid food product comprising an isothiocyanate compound;
(b) exposing the solid food product to energy input causing thermal heat in any portion of the product;
wherein at least any portion of the solid food product exhibits a temperature of at least about 37° C. for at least about 30 seconds.

11. The method according to claim 10 comprising exposing the solid food product to heat, wherein at least a portion of the solid food product exhibits a temperature of at least about 42° C. for at least about 2 minutes.

12. The method according to claim 11 comprising at least about 100 ppm of the isothiocyanate compound, wherein the isothiocyanate compound is a moisture-sensitive isothiocyanate compound.

13. The method according to claim 12 comprising at least about 450 ppm of the moisture-sensitive isothiocyanate compound, wherein the moisture-sensitive isothiocyanate compound is 4-hydroxybenzyl isothiocyanate.

14. The method according to claim 13 comprising exposing the solid food product to heat, wherein at least a portion of the solid food product exhibits a temperature of at least about 57° C. for at least about 3 minutes.

15. The method according to claim 14 wherein a substantial portion of the solid food product exhibits a temperature of at least about 57° C. for at least about 3 minutes.

16. The method according to claim 15 wherein the solid food product comprises at least one vegetable.

17. The method according to claim 15 wherein the solid food is exposed to heat by microwave radiation.

18. The method according to claim 15 wherein the solid food product is substantially frozen prior to exposing the solid food product to the heat.

19. A solid food product comprising an isothiocyanate compound, wherein the solid food product is substantially frozen.

20. The solid food product according to claim 19 comprising at least about 100 ppm of the isothiocyanate compound.

21. The solid food product according to claim 20 wherein the isothiocyanate compound is a moisture-sensitive isothiocyanate compound.

22. The solid food product according to claim 21 wherein the moisture-sensitive isothiocyanate compound is 4-hydroxybenzyl isothiocyanate.

23. The solid food product according to claim 22 comprising at least about 450 ppm of the 4-hydroxybenzyl isothiocyanate.

24. The solid food product according to claim 23 comprising at least about 750 ppm of the 4-hydroxybenzyl isothiocyanate.

25. The solid food product according to claim 23 comprising a sauce.

26. The solid food product according to claim 25 which is a pot pie.

27. The solid food product according to claim 23 comprising at least one vegetable.

28. The solid food product according to claim 27 which is a pot pie.

29. The solid food product according to claim 22, wherein the solid food product is frozen.
